(19) United States
(12) Patent Application Publication
(10) Pub. No.: US 2014/0059065 A1
(43) Pub. Date: Feb. 27, 2014

(54) MANAGEMENT OF NETWORK-BASED DIGITAL DATA REPOSITORY

(71) Applicants: Ricardo D. Cortes, Los Gatos, CA (US); Max Muller, San Jose, CA (US)

(72) Inventors: Ricardo D. Cortes, Los Gatos, CA (US); Max Muller, San Jose, CA (US)

(21) Appl. No.: 13/595,918

(22) Filed: Aug. 27, 2012

(51) Int. Cl. G06F 17/30

(52) U.S. Cl. 707/758; 707/E17.044

(57) ABSTRACT

Improved techniques and systems for determining equivalency of digital assets are disclosed. The techniques and systems are suitable and useful for storing, delivering and accessing digital assets to or from a network-based digital data repository (e.g., cloud data storage). One aspect disclosed is that processing can be performed to determine whether digital assets are equivalent. Such processing can, in one embodiment, use multi-tier fingerprinting to determine equivalency of digital assets. In another embodiment, processing can use descriptive information (e.g., metadata) to assist in determining equivalency of digital assets. In another embodiment, a database can store equivalency information to provide “caching” of equivalency results for subsequent efficient determinations of equivalency. The digital assets become accessible from the network-based digital data repository via electronic devices (e.g., user devices) and thus usable by the electronic devices. The digital assets can include media assets and/or non-media assets.

### BACKGROUND OF THE INVENTION

Online stores and online shopping have become increasing more popular in recent years. Desktop and laptop computers have been used to purchase various goods and services from online stores. An online store may allow customers, via a network connection to the Internet, to browse, search and purchase various different items from the online store. Purchased items can be delivered by mail or make available for pickup at a store or another location.

Recently, digital assets (e.g., musical songs, movies, computer application programs) have become available for purchase from online stores. Moreover, digital assets have become available for delivery directly to the device used to purchase them. As such, today, a digital asset can be purchased from an online store by way of an electronic device (e.g., a desktop computer) from a residence and immediately delivered to the electronic device used to acquire the digital asset. In other words, after purchasing a digital asset from an online store via an electronic device, the digital asset can be “downloaded” by the electronic device for subsequent use thereon.

However, more recently, the number and variety of electronic devices with the ability to access online stores have dramatically increased. Today, a person may own and/or operate several electronic devices with the ability to access online stores, including a desktop computer, a laptop computer, a pad or tablet computer (e.g., iPad™), a smartphone, a media player, a gaming device, a television, and so on. In addition, an ever increasing number and types of digital assets are becoming available at online stores for various electronic devices, including, media, books, application programs, etc. As a result, management of delivery of digital assets to electronic devices can pose difficulties for users, especially those maintaining collections of various digital assets on several distinct electronic devices.

Also, in various situations, distribution and/or management of digital assets for online stores and/or users can have a need to determine whether one digital asset is considered equivalent to another digital asset. The determination of equivalency often consumes a significant amount of computing resources. Hence, if there are many equivalency determinations to be made, the determination of equivalency can be burdensome and time consuming. Accordingly, there is a need for improved techniques and systems for determining equivalency of digital assets.

### SUMMARY

Improved techniques and systems for determining equivalency of digital assets are disclosed. The techniques and systems are suitable and useful for storing, delivering and accessing digital assets to or from a network-based digital data repository (e.g., cloud data storage).

One aspect disclosed is that processing can be performed to determine whether digital assets are equivalent. Such processing can, in one embodiment, use multi-tier fingerprinting to determine equivalency of digital assets. In another embodiment, processing can use descriptive information (e.g., metadata) to assist in determining equivalency of digital assets. In another embodiment, a database can store equivalency information to provide “caching” of equivalency results for subsequent efficient determinations of equivalency. The digital assets become accessible from the network-based digital data repository via electronic devices (e.g., user devices) and thus usable by the electronic devices. The digital assets can include media assets and/or non-media assets.

Another aspect of certain embodiments pertains to evaluating digital data, such as digital data assets, to determine whether the same digital data at a user's client device is already previously stored in cloud data storage. If so, the user can gain access to the digital data via the cloud data storage without having to upload such digital data from the user's client device to the cloud data storage. In one embodiment, a multi-tiered fingerprint process can be used to determine whether digital assets are the equivalent (i.e., match). In another embodiment, initial processing using metadata can be performed to pre-filter out digital assets that are likely to be equivalent, which can serve to make subsequent fingerprint processing more targeted.

The invention can be implemented in numerous ways, including as a method, system, device, or apparatus (including computer readable medium). Several embodiments of the invention are discussed below.

As a method for identifying equivalent data items, one embodiment can, for example, include at least: receiving a partial digital fingerprint for a local data item, the local digital data item being stored at a client device; first comparing the partial digital fingerprint for the local digital data item with a partial digital fingerprint for a plurality of remote digital data items, the remote digital data items being stored to a remote data repository associated with a remote server device; identifying a set of one or more of the remote digital data items that match the local digital data item based on results of the first comparing; receiving a full digital fingerprint for the local data item; second comparing the full digital fingerprint for the local digital data item with a full digital fingerprint for the one or more of the remote digital data items in the set of one or more of the remote digital data items; and identifying at least one of the set of one or more of the remote digital data items that match the local digital data item based on results of the second comparing.

As a non-transitory computer readable medium including at least computer program code stored therein for identifying equivalent data items at remote data repository, one embodiment can, for example, include at least: computer program code for receiving a partial digital fingerprint for a local data item, the local digital data item being stored at a client device; first computer program code for requesting comparison of the partial digital fingerprint for the local digital data item with a partial digital fingerprint for a plurality of remote digital data items, the remote digital data items being stored at the remote data repository; computer program code for receiving an indication of a set of one or more of the remote digital data items that match the local digital data item based on results of the comparison by the first computer program code; computer program code for receiving a full digital fingerprint for the local data item; second computer program code for requesting comparison the full digital fingerprint for the local digital data item with a full digital fingerprint for the one or more of the remote digital data items in the set of one or more of the remote digital data items; and computer program code for receiving an indication of at least one of the set of one or more of the remote digital data items that match the local digital data item based on results of the comparison by the second computer program code.

As a system for providing a network-based repository accessible by client devices via a network, one embodiment can, for example, include at least a remote data repository and at least one server. The remote data repository can be configured to store digital data for a plurality of account holders. The remote data repository can be accessible by authorized client devices via the network. The at least one server computing device can be operatively connected to the remote data repository. The at least one server can be configured to: receiving a partial digital fingerprint for a local data item, the local digital data item being stored at a client device; initiating comparison of the partial digital fingerprint for the local digital data item with a partial digital fingerprint for a plurality of remote digital data items; identifying a set of one or more of the remote digital data items that match the local digital data item based on results of the initiating of the comparison of the partial digital fingerprint for the local digital data item with the partial digital fingerprint for the remote digital data items; receiving a full digital fingerprint for the local data item; initiating comparison of the full digital fingerprint for the local digital data item with a full digital fingerprint for the one or more of the remote digital data items in the set of one or more of the remote digital data items; and identifying at least one of the set of one or more of the remote digital data items that match the local digital data item based on results of the initiating of the comparison of the full digital fingerprint for the local digital data item with the full digital fingerprint for the one or more of the remote digital data items in the set of one or more of the remote digital data items.

Various aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 illustrates a block diagram of a network-based data management system according to one embodiment.

FIGS. 2A and 2B illustrate a flow diagram of a cloud activation process according to one embodiment.

FIG. 3A illustrates a flow diagram of a data matching process according to one embodiment.

FIG. 3B illustrates a flow diagram of match processing according to one embodiment.

FIG. 3C illustrates a flow diagram of match processing according to another embodiment.

FIG. 3D illustrates a flow diagram of match processing according to still another embodiment.

FIGS. 4A and 4B illustrate a flow diagram of a data matching process according to one embodiment.

FIGS. 5A-5C illustrate a flow diagram of a data matching process according to one embodiment.

FIGS. 6A and 6B illustrate flow diagrams of a data match process according to one embodiment.

### DETAILED DESCRIPTION OF EMBODIMENTS OF THE INVENTION

Improved techniques and systems for determining equivalency of digital assets are disclosed. The techniques and systems are suitable and useful for storing, delivering and accessing digital assets to or from a network-based digital data repository (e.g., cloud data storage).

One aspect disclosed is that processing can be performed to determine whether digital assets are equivalent. Such processing can, in one embodiment, use multi-tier fingerprinting to determine equivalency of digital assets. In another embodiment, processing can use descriptive information (e.g., metadata) to assist in determining equivalency of digital assets. In another embodiment, a database can store equivalency information to provide “caching” of equivalency results for subsequent efficient determinations of equivalency. The digital assets become accessible from the network-based digital data repository via electronic devices (e.g., user devices) and thus usable by the electronic devices. The digital assets can include media assets and/or non-media assets.

Another aspect of certain embodiments pertains to evaluating digital data, such as digital data assets, to determine whether the same digital data at a user's client device is already previously stored in cloud data storage. If so, the user can gain access to the digital data via the cloud data storage without having to upload such digital data from the user's client device to the cloud data storage. In one embodiment, a multi-tiered fingerprint process can be used to determine whether digital assets are the equivalent (i.e., match). In another embodiment, initial processing using metadata can be performed to pre-filter out digital assets that are likely to be equivalent, which can serve to make subsequent fingerprint processing more targeted.

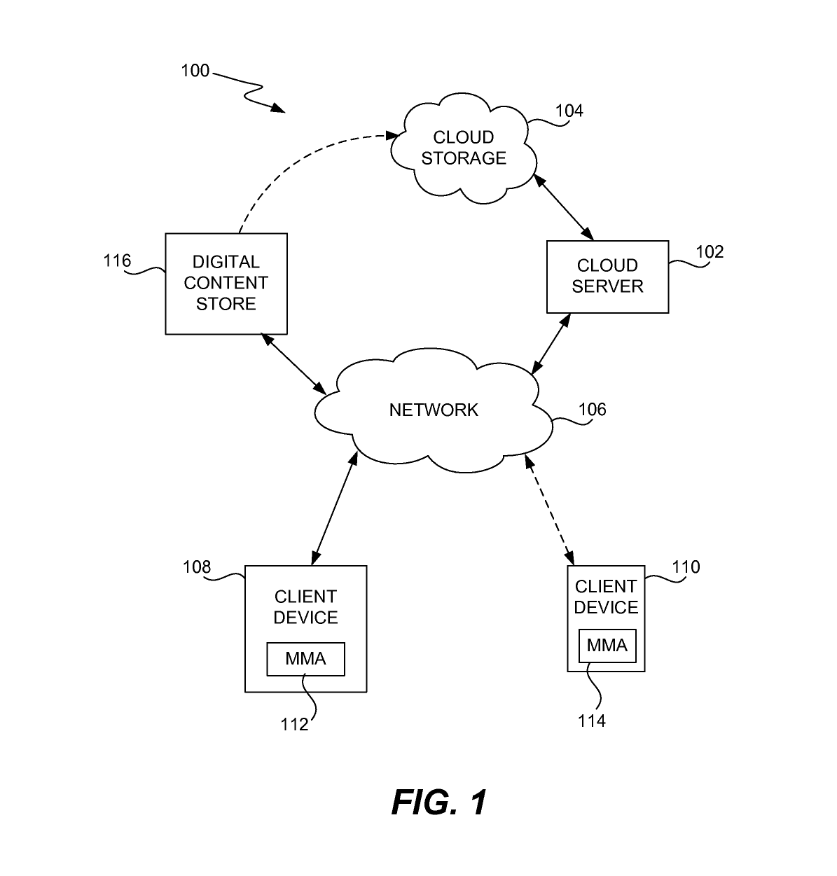

Exemplary embodiments of the invention are discussed below with reference to FIGS. 1-6B. However, those skilled in the art will readily appreciate that the detailed description given herein with respect to these figures is for explanatory purposes as the invention extends beyond these limited embodiments.

FIG. 1 illustrates a block diagram of a network-based data management system 100 according to one embodiment. The network-based data management system 100 provides data management for a plurality of different users. The various users can operate one or more client devices to access data being stored remotely by the network-based data management system 100. The network-based data management system 100 can also manage synchronization of data between multiple client devices associated with a particular user.

The network-based data management system 100 includes a cloud server 102. The cloud server 102 can represent or be implemented by one or more electronic devices, such as one or more computing devices (e.g., one or more server computers). The cloud server 102 is coupled to cloud storage 104. The cloud storage 104 provides a large amount of digital data storage that is coupled to a network 106. The cloud storage 106 can store digital data for a large number of different users. Although the cloud storage 104 is shared amongst a large number of different users, the digital data being stored for a given user can be accessible only by the given user. The cloud server 102 can serve to manage storage, access and distribution of data to and from the data storage by the cloud storage 104. The cloud storage 104 can also facilitate synchronization of data for users making use of the cloud storage 104. The cloud storage 104 is accessible by way of the cloud server 102 by client devices associated with users. For example, as illustrated in FIG. 1, client device 108 and client device 110 can be coupled to the network 106 so as to gain access to data stored in the cloud storage 104. The client devices 108 and 110 can represent electronic devices, such as computing devices. For example, the client device 108 can represent a computer, while the client device 110 can represent a mobile phone. Typically, the client devices 108 and 110 include an application program (or utility or operating system program) that facilitates access to the cloud server 102 by way of the network 106. The network 106 can consist of one or more wired or wireless networks. The client device 108 can, for example, connect to the network 106 by a wired connection, and the client device 110 can, for example, connect to the network 106 by a wireless connection.

Additionally, the client device 108 can include an application program, such as a media management application 112, that facilitates access, presentation and utilization of data stored either locally at the client device 108 or remotely at the cloud storage 104. Similarly, the client device 110 can include an application program, such as a media management application 114, that facilitates access, presentation and utilization of data stored either locally at the client device 110 or remotely at the cloud storage 104.

Still further, the network-based data management system 100 can include a digital content store 116. The digital content store 116 can facilitate electronic commerce to purchase, rent or otherwise acquire digital content. For example, the digital content store 116 can pertain to a digital media store (i.e., online store) that offers digital content, such as movies, songs, audio books, applications, and/or games for purchase, rental or utilization. Additionally, if a user of the client device 108 or 110 were to purchase a digital media item from the digital content store 116, the digital media item could be downloaded to the corresponding client device 108 or 110 as well as also provided to the cloud storage 104. Hence, the cloud storage 104 can store the purchased digital media item (or at least a link to the stored content) such that any of the user's client devices authorized for usage can access the cloud storage 104 associated with the user to gain access to the purchased digital media item. In this way, the purchase digital media item is directly added to the cloud storage 104 and thus does not need to be uploaded from the purchasing client device. Also, any of the user's other client devices that are authorized can also access (including downloading) the purchased digital media item from the cloud storage 104.

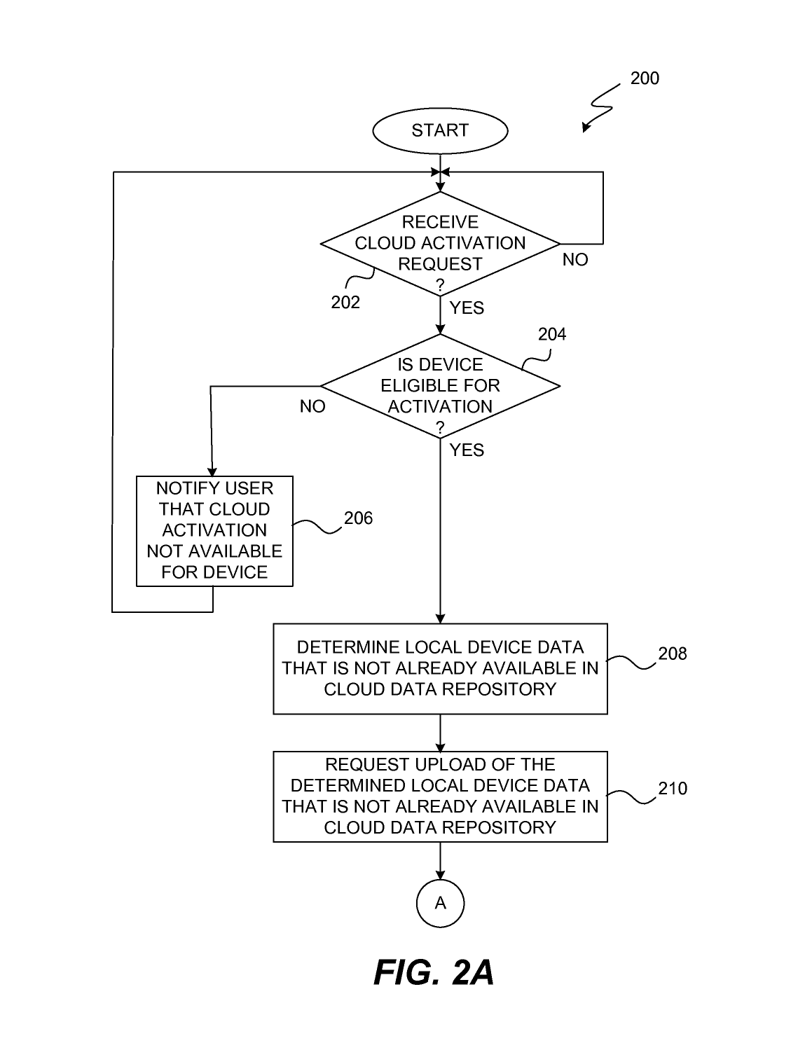

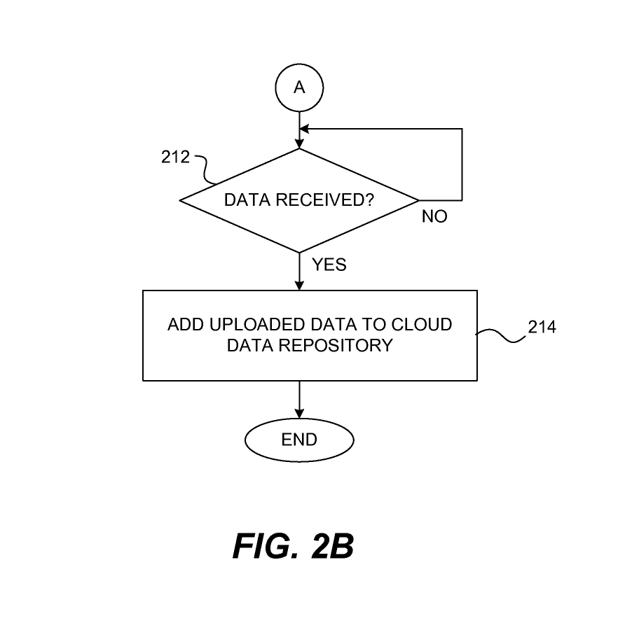

FIGS. 2A and 2B illustrate a flow diagram of a cloud activation process 200 according to one embodiment. The cloud activation process 200 can be performed by a computing device, such as the cloud server 102 illustrated in FIG. 1.

The cloud activation process 200 can begin with a decision 202 that determines whether a cloud activation request has been received from a client device. When the decision 202 determines that a cloud activation request has not yet been received, the cloud activation process 200 can await such a request. Once the decision 202 determines that a cloud activation request has been received from a particular client device, a decision 204 can determine whether the particular client device is eligible for activation. In one embodiment, cloud activation can be available to only a limited number of client devices associated with a given user. In general, eligibility can be established by predetermined rules or policies that govern the number, type and/or timing for activation eligibility.

When the decision 204 determines that the particular client device is not eligible for activation, the user can be notified 206 that cloud activation is not available for the particular client device. Following the notification 206, the cloud activation process 200 can return to repeat the decision 202 and subsequent blocks so the cloud activation can be continuously monitored if so desired.

On the other hand, when the decision 204 determines that the particular client device is eligible for activation, additional processing can be performed to upload any local data from the particular client device to cloud storage (e.g., cloud storage 104) to a cloud data repository (remote data repository). However, for efficient use of network bandwidth and storage as well as for energy conservation, processing can be performed to upload only that portion of the local data that is not already available in the cloud storage. In particular, when the decision 204 determines that the particular client device is eligible for activation, the cloud activation process 200 can determine 208 local device data that is not already available in the cloud storage.

Next, upload of the determined local device data that is not already available in the cloud data repository can be requested 210. A decision 212 can determine whether the requested local device data has been received. Here, the cloud activation process 200 can determine whether the data that has been requested to be uploaded from the particular client device has been received. When the decision 212 determines that such data has not yet been received, the cloud activation process 200 can await such data. Once the decision 212 determines that the requested data to be uploaded has been received, the uploaded data can be added 214 to the cloud data repository. After the uploaded data has been added 214 to the cloud data repository, the cloud activation process 200 can end. Following conclusion of the cloud activation process 200, the particular client device has in effect been activated for use of the cloud storage, whereby the local device data from the client device is rendered available from the cloud data repository and thus can be accessed by other client devices of the same user.

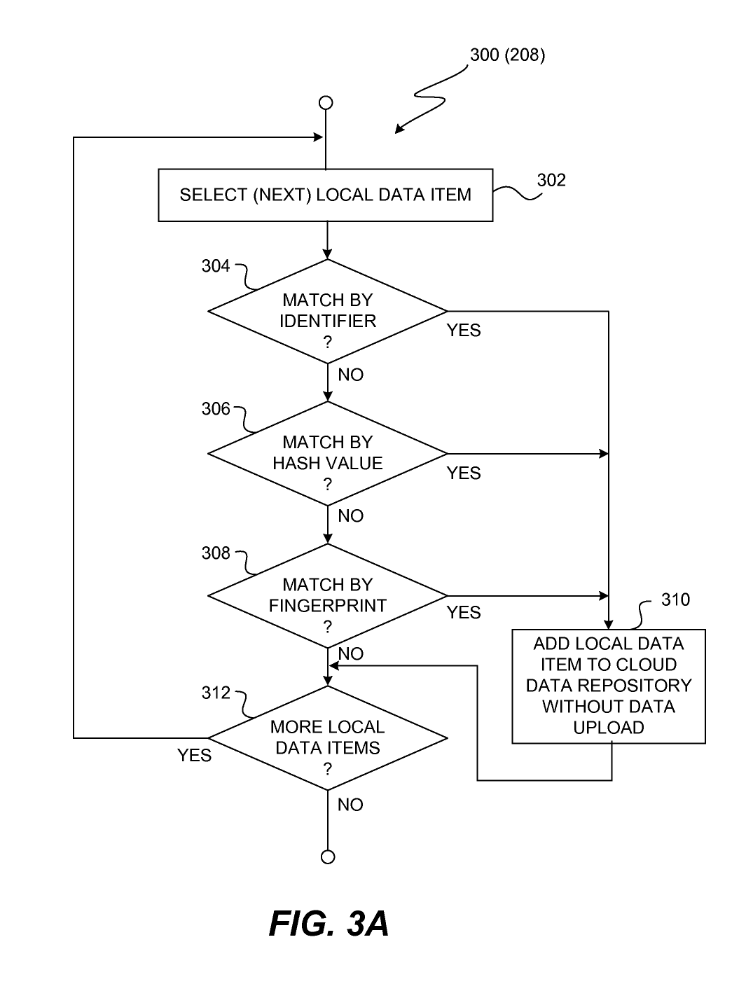

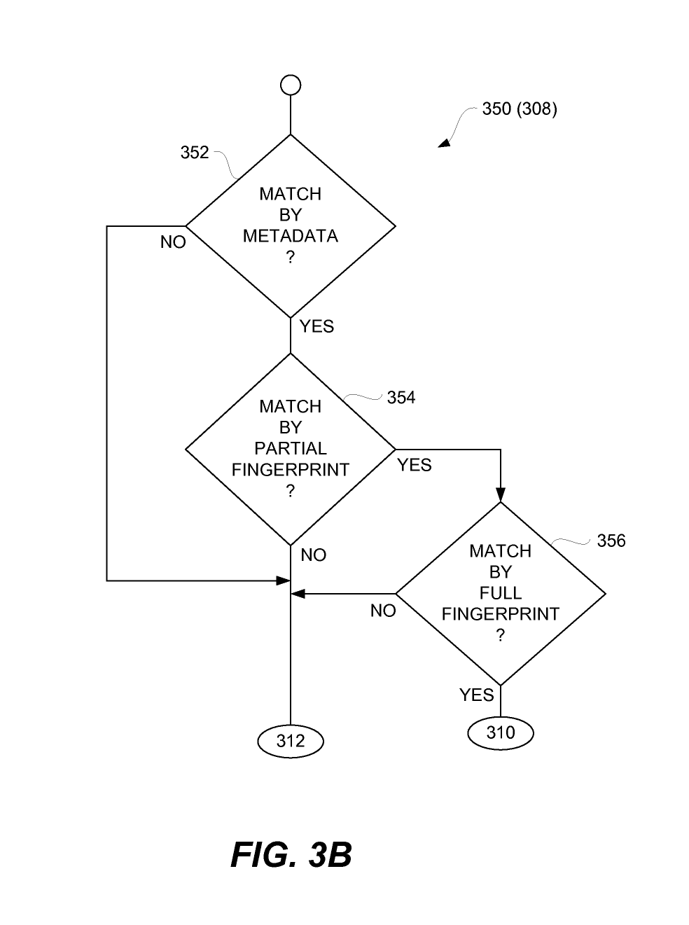

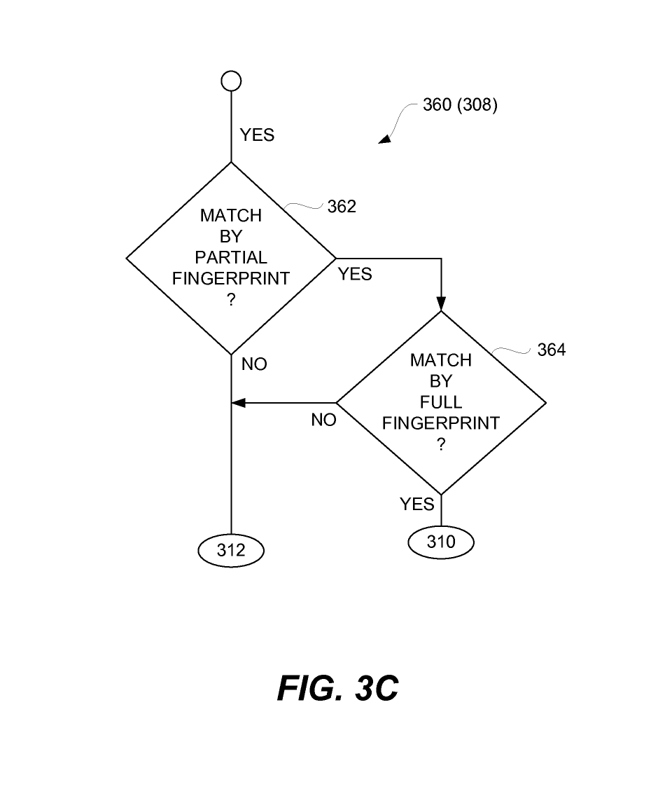

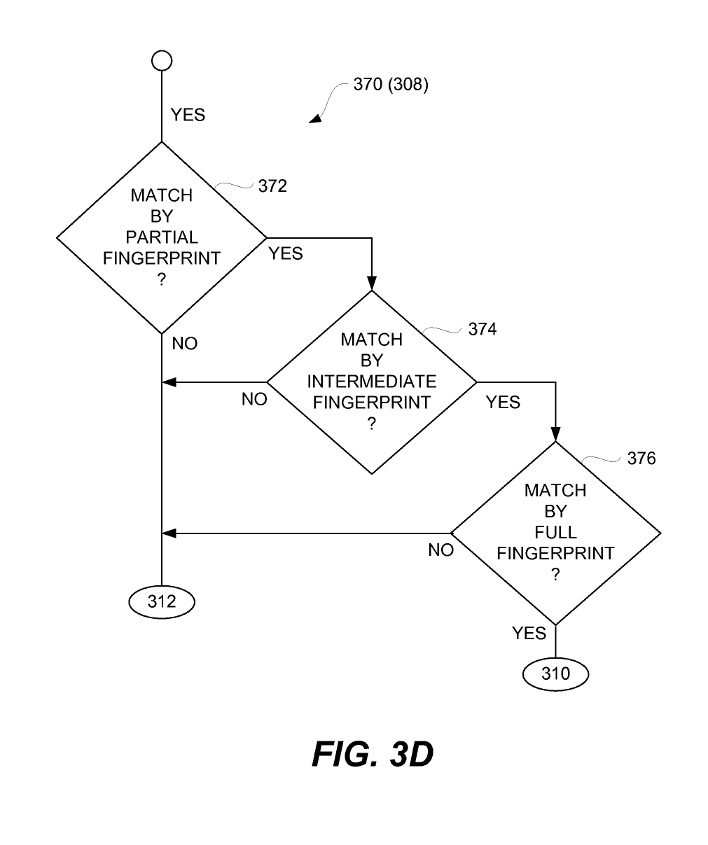

FIG. 3A illustrates a flow diagram of a data matching process 300 according to one embodiment. The data matching process 300 can, for example, represent processing performed by the block 208 illustrated in FIG. 2A. The data matching process 300 can be performed by a computing device, such as the cloud server 102 illustrated in FIG. 1.

The data matching process 300 can select 302 a local data item from local device data that is stored on the particular client device being activated. The local data item can, for example, be a digital asset. The digital asset can pertain to a media item (song, video, e-book, podcast), an application program, electronic document, electronic presentation, etc.

A decision 304 can then determine whether the selected local data item can be matched through use of one or more identifiers. Depending upon where the selected local data item was acquired from, the selected local data item may include one or more identifiers. Through use of these one or more identifiers, the cloud server 102 can evaluate whether a cloud data repository (e.g., cloud storage 104) already stores the same exact data item (or perhaps same data item but of greater quality). For example, if the local data item was purchased and downloaded from an online store (e.g., digital content store 116), then the local data item can include or associate to one or more identifiers that may be known to the cloud server 102, particularly if the cloud server 102 is affiliated with the online store or if a global or standard identifier is used. The identifiers are typically numeric or alphanumeric values that are centrally assigned by a computing device, such as the cloud server 102. In one embodiment, the identifiers are associated with a user cloud storage space. In another embodiment, the identifiers are globally assigned across multiple or all users.

If the selected local data item is not able to be matched by way of one or more identifiers, a decision 306 can determine whether the selected local data item can be matched by a hash value. Here, the selected local data item can be represented as a hash value that can be compared by the cloud server 102 with hash values of data items already stored at the cloud data repository.

If the selected local data item is not able to be matched by way of its hash value, a decision 308 can determine whether the selected local data item can be matched by a fingerprint. The fingerprint can be created by a predetermined algorithm and can represent a presumptively unique electronic fingerprint of the data item. In this case, the selected local data item can be processed at the client device to provide a fingerprint. The fingerprint can then be provided to the cloud server 102 which can evaluate whether the fingerprint provided by the client device matches any fingerprints for data items already stored at the cloud data repository.

If the selected local data item is able to be matched by any of the one or more identifiers, the hash value or the fingerprint, the selected local data item can be added 310 to the cloud data repository without any uploaded data (i.e., without any content upload). In this case, since the selected local data item is able to be matched with an existing data item already resident in the cloud data repository, the uploading of such data item is not necessary as the local data item can be associated with the data item already existing in the cloud data repository. Consequently, network resources and energy that would otherwise be consumed to transmit and store the data item can be conserved.

When the decision 308 determines that the selected local data item is not able to be matched by fingerprint, as well as following the block 310 when matching has occurred, a decision 312 can determine whether there are more local data items to be processed. When the decision 312 determines that there are more local data items to be processed, the data matching process 300 can return to repeat the block 302 so that another local data item can be selected and similarly processed. When the decision 312 determines that there are no more local data items to be processed, the data matching process 300 can end.

FIG. 3B illustrates a flow diagram of match processing 350 according to one embodiment. The match processing 350 can represent more detailed processing that can be performed to implement the decision 308 of the data match process 300, according to one embodiment. Hence, the match processing 350 is described with reference to replacement of the decision 308. However, it should be understood that the match processing 350 could also be used with only some of the digital match process 300 shown in FIG. 3A. For example, the match processing 350 could implement the decision 308 of the data match process 300, but without using one or both of the decisions 304 and 306 illustrated in FIG. 3A.

According to the match processing 350, a decision 352 can determine whether a local data item can be matched through use of metadata. A local data item has certain metadata associated therewith that can be used in an attempt to locate the same or equivalent data item already stored in the cloud data repository. For example, if the local media item pertains to a song, the metadata being utilized to evaluate whether a match can be found can include artist name, song title, album, title, and duration (e.g., length). When the decision 352 determines that the metadata for the local data item is not found to match the metadata for any of the data items already stored in the cloud data repository, then the match processing 350 can proceed to the decision 312 since, in this case, it can be concluded that there is no matching data item already stored in the cloud data repository.

Alternatively, when the decision 352 determines that metadata for the local data item is found to match the metadata for one or more of the data items already stored in the cloud data repository, additional processing can be performed to more specifically confirm that the local data item is already stored as one of the data items in the cloud data repository. The additional processing can begin with a decision 354 that can determine whether a partial fingerprint for the local data item can be found to match a partial fingerprint for one or more data items already stored in the cloud data repository. A partial fingerprint is a digital acoustic fingerprint derived from a portion of the corresponding data item. Hence, typically for fingerprint matching the local data item is an audio item (e.g., music (including sound track), podcast, e-book). A partial fingerprint for an audio item can be a digital acoustic fingerprint derived from a brief duration of the audio item. For example, if the audio item might have a duration of two (2) or more minutes, but the partial fingerprint only considers a short segment of the audio item, such as 10 to 40 seconds. A partial fingerprint can be computed faster and can be provided by an outside service for at relatively low cost. A full fingerprint is also a digital acoustic fingerprint but is more computationally intensive and more costly since the entire audio item is processed. Typically, an acoustic fingerprint algorithm takes into account perceptual characteristics of the audio. With acoustic fingerprints, if two audio items sound alike to a human ear, their acoustic fingerprints should be considered to match. Although there are various service providers that produce fingerprints for audio items, one example of a suitable remote service is Gracenote's MusicID, which is a commercial product that uses acoustic fingerprinting to identify music.

When the decision 354 determines that the partial fingerprint for the local data item has been found to match a partial fingerprint for one or more data items already stored in the cloud data repository, still further fingerprint processing can be performed to further validate equivalency of the corresponding media items. In such case, a decision 356 can determine whether a full fingerprint for the local data item can be found to match a full fingerprint for the one or more data items already stored in the cloud data repository that have been previously matched through use of the partial fingerprints (as well as the metadata). Here, the decision 356 can, in one implementation, only consider the full fingerprints for those data items at the cloud data repository that have been previously processed with respect to the partial fingerprints and found to be matching.

When the decision 356 determines that the full fingerprint for the local data item is found to match a full fingerprint for one of the data items already stored in the cloud data repository, the match processing 350 is completed because the local media item has been found to match the data item already stored on the cloud data repository. In such case, further processing can proceed to block 310 illustrated in FIG. 3A where the local data item is made available to an appropriate user from the cloud data repository without having to be uploaded to the cloud data repository.

On the other hand, when the decision 356 determines that the full fingerprint for the local data item is not found to match a full fingerprint for any of the one or more data items already stored in the cloud data repository, or when the decision 354 determines that a partial fingerprint for the local data item has not been found to match a partial fingerprint for the one or more data items already stored in the cloud data repository, then the match processing 350 can conclude. In this case, the match processing 350 can proceed to the decision 312 of the match processing 300 illustrated in FIG. 3A since, in this case, it has been concluded that there is no matching data item already stored in the cloud data repository.

FIG. 3C illustrates a flow diagram of match processing 360 according to another embodiment. The match processing 360 can represent more detailed processing that can be performed to implement the decision 308 of the data match process 300, according to one embodiment. Hence, the match processing 360 is described with reference to replacement of the decision 308. However, it should be understood that the match processing 360 could also be used with only some of the digital match process 300 shown in FIG. 3A. For example, the match processing 360 could implement the decision 308 of the data match process 300, but without using one or both of the decisions 304 and 306 illustrated in FIG. 3A.

According to the match processing 360, a decision 362 that can determine whether a partial fingerprint for a local data item can be found to match a partial fingerprint for one or more data items already stored in the cloud data repository. When the decision 362 determines that a partial fingerprint for the local data item has been found to match a partial fingerprint for one or more data items already stored in the cloud data repository, further fingerprint processing can be performed to further validate equivalency of the corresponding media items. In such case, a decision 364 can determine whether a full fingerprint for the local data item can be found to match a full fingerprint for the one or more data items already stored in the cloud data repository that have been previously matched through use of the partial fingerprints. Here, the decision 364 can, in one implementation, only consider the full fingerprints for those data items at the cloud data repository that have been previously processed with respect to the partial fingerprints and found to be matching.

When the decision 364 determines that the full fingerprint for the local data item is found to match a full fingerprint for one of the data items already stored in the cloud data repository, the match processing 360 is completed because the local media item has been found to match the data item already stored on the cloud data repository. In such case, further processing can proceed to block 310 illustrated in FIG. 3A where the local data item is made available to an appropriate user from the cloud data repository without having to be uploaded to the cloud data repository.

On the other hand, when the decision 364 determines that the full fingerprint for the local data item is not found to match a full fingerprint for any of the one or more data items already stored in the cloud data repository, or when the decision 362 determines that a partial fingerprint for the local data item has not been found to match a partial fingerprint for the one or more data items already stored in the cloud data repository, then the match processing 360 can conclude. In this case, the match processing 360 can proceed to the decision 312 of the match processing 300 illustrated in FIG. 3A since, in this case, it has been concluded that there is no matching data item already stored in the cloud data repository.

FIG. 3D illustrates a flow diagram of match processing 370 according to still another embodiment. The match processing 370 can represent more detailed processing that can be performed to implement the decision 308 of the data match process 300, according to one embodiment. Hence, the match processing 370 is described with reference to replacement of the decision 308. However, it should be understood that the match processing 370 could also be used with only some of the digital match process 300 shown in FIG. 3A. For example, the match processing 360 could implement the decision 308 of the data match process 300, but without using one or both of the decisions 304 and 306 illustrated in FIG. 3A.

According to the match processing 370, a decision 372 that can determine whether a partial fingerprint for a local data item can be found to match a partial fingerprint for one or more data items already stored in the cloud data repository. When the decision 372 determines that a partial fingerprint for the local data item has been found to match a partial fingerprint for one or more data items already stored in the cloud data repository, further fingerprint processing can be performed to further validate equivalency of the corresponding media items. In such case, a decision 374 can determine whether an intermediate fingerprint for the local data item can be found to match an intermediate fingerprint for the one or more data items already stored in the cloud data repository that have been previously matched through use of the partial fingerprints. Here, the decision 374 can, in one implementation, only considers the intermediate fingerprints for those data items at the cloud data repository that have been previously processed with respect to the partial fingerprints and found the partial fingerprints to be matching. An intermediate fingerprint is an acoustic fingerprint that is more robust than a partial fingerprint, but less robust than a full fingerprint. For example, an intermediate fingerprint can be an acoustic fingerprint that corresponds to a duration of a data item that is longer than a duration for a partial fingerprint but less than a duration of a full fingerprint.

When the decision 376 determines that the intermediate fingerprint for the local data item has been found to match an intermediate fingerprint for one or more data items already stored in the cloud data repository, further fingerprint processing can be performed to further validate equivalency of the corresponding media items. In such case, a decision 376 can determine whether a full fingerprint for the local data item can be found to match a full fingerprint for the one or more data items already stored in the cloud data repository that have been previously matched through use of the intermediate fingerprints. Here, the decision 376 can, in one implementation, only consider the full fingerprints for those data items at the cloud data repository that have been previously processed with respect to the intermediate fingerprints and found the intermediate fingerprints to be matching.

When the decision 376 determines that the full fingerprint for the local data item is found to match a full fingerprint for one of the data items already stored in the cloud data repository, the match processing 370 is completed because the local media item has been found to match the data item already stored on the cloud data repository. In such case, further processing can proceed to block 310 illustrated in FIG. 3A where the local data item is made available to an appropriate user from the cloud data repository without having to be uploaded to the cloud data repository.

On the other hand, when the decision 376 determines that the full fingerprint for the local data item is not found to match a full fingerprint for any of the one or more data items already stored in the cloud data repository, when the decision 374 determines that the intermediate fingerprint for the local data item is not found to match an intermediate fingerprint for any of the one or more data items already stored in the cloud data repository, or when the decision 372 determines that the partial fingerprint for the local data item has not been found to match a partial fingerprint for the one or more data items already stored in the cloud data repository, then the match processing 370 can conclude. In this case, the match processing 370 can proceed to the decision 312 of the match processing 300 illustrated in FIG. 3A since, in this case, it has been concluded that there is no matching data item already stored in the cloud data repository. Alternatively, in some cases, matching can be deemed sufficient even though only partial or intermediate fingerprints match (and full fingerprints do not match or have not been attempted).

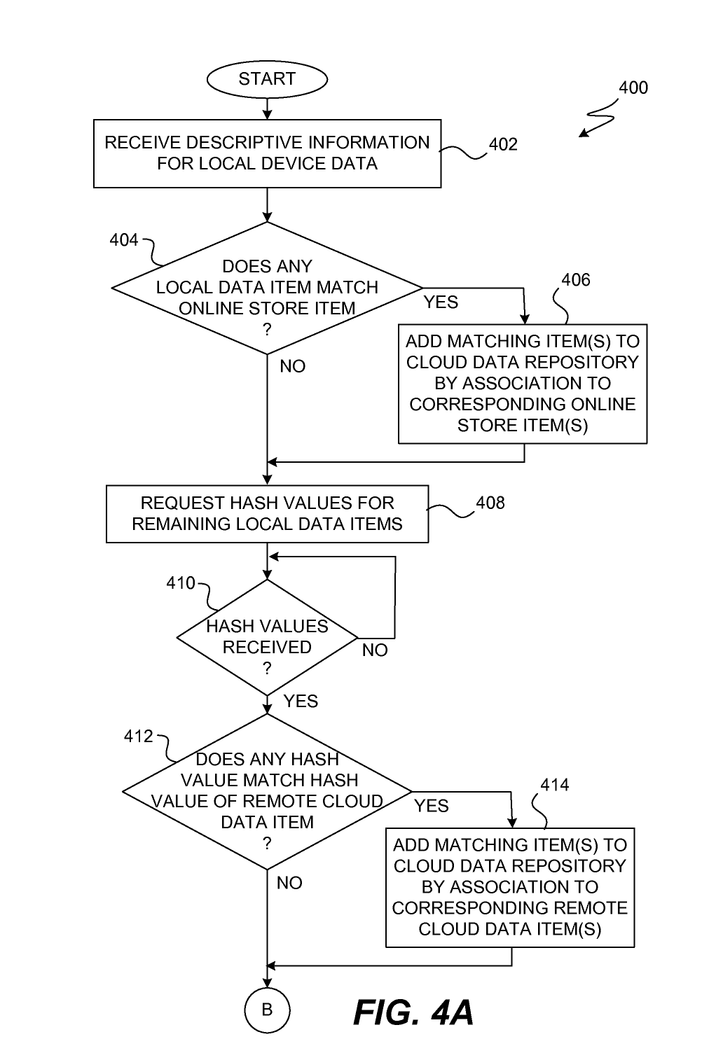

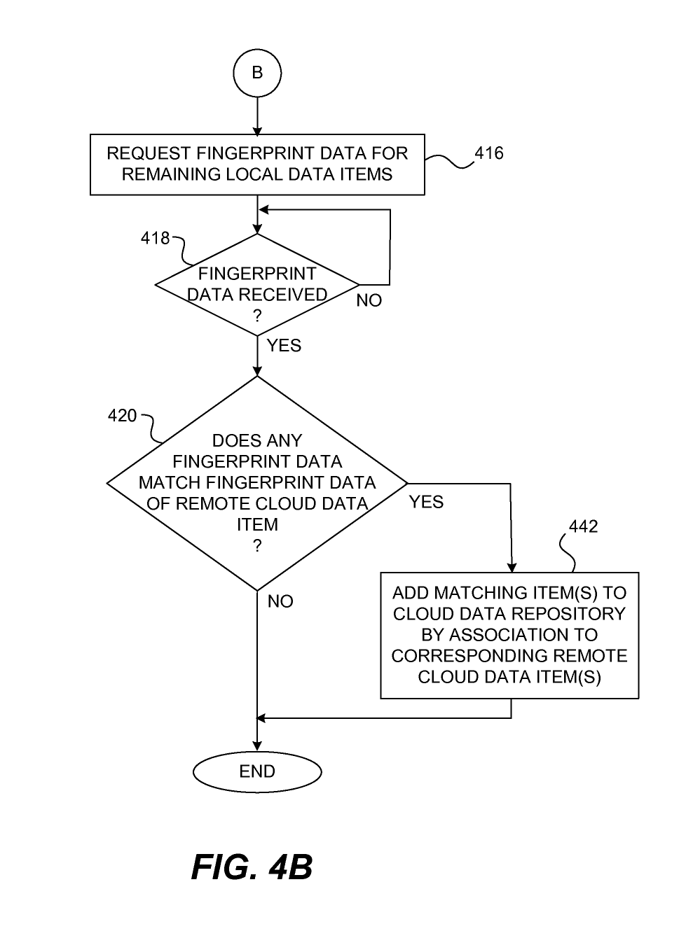

FIGS. 4A and 4B illustrate a flow diagram of a data matching process 400 according to one embodiment. The data matching process 400 can, for example, represent a more detailed process than the processing performed by the block 208 illustrated in FIG. 2A or the data matching process 300 illustrated in FIG. 3A. The data matching process 400 can be performed by a computing device, such as the cloud server 102 illustrated in FIG. 1.

The data matching process 400 can receive 402 descriptive information for local device data. The descriptive information serves to describe characteristics or attributes for the local device data. As an example, the descriptive information can include metadata well as one or more identifiers for the various device data items within the local device data. The metadata can describe the corresponding data items. For example, for a digital media asset, the metadata can specify attributes such as title, artist, genre, user-rating, etc. The metadata might also specify characteristics such as bit rate, encoding, duration, etc. The one or more identifiers are typically assigned such that they are unique for a given digital item. For example, an online store (e.g., digital content store 116) can assign unique identifiers to each of its digital online store items that are offered to users for acquisition.

Next, a decision 404 can determine whether any of the local data items match with an online store item. Here, the one or more identifiers provided in the descriptive information can be utilized to compare to identifiers associated with online store items available at the online store. When the decision 404 determines that there is a match, the match indicates that the local data item was acquired from the online store and thus has a matching identifier. In this case, the one or more matched items can be added 406 to the cloud data repository by association to one or more corresponding online store items.

Alternatively, when the decision 404 determines that none of local data items match the online store items, or following the block 406 in the case in which there are one or more matches, hash values for the remaining local data items can be requested 408. Here, the computing device performing the data matching process 400 (e.g., cloud server 102) can request the hash values from the particular client device being activated. In determining the hash values for a data item, metadata (or descriptive information), if present, could (but need not) be hashed together with content of the data item. A decision 410 can then determine whether the requested hash values have been received. When the decision 410 determines that the requested hash values have not yet been received, the data matching process 400 can await the requested hash values.

Once the decision 410 determines that the requested hash values have been received, a decision 412 can determine whether any of the hash values match any hash values of remote cloud data items. Here, the hash values pertain to a digital identifier that is computed from the electronic file containing or associated with a given local data item. The hash value can thus be used to identify identical electronic files. As an example, the hash value utilized can result from using an MD5 hash algorithm. When the decision 412 determines that one or more hash values for local data items match one or more hash values for remote cloud data items, the one or more corresponding local data items can be thus identified as each matching a remote cloud data item already provided in the cloud storage. Hence, in this case, the one or more matching items can be added 414 to the cloud data repository by association to one or more corresponding remote cloud data items.

Moreover, following the decision 412 when their are no hash values that match hash values of remote cloud data items, or following the block 414 when there are matching items, the data matching process 400 can request fingerprint data for any of the remaining local data items. The fingerprint data for a data item is an acoustic fingerprint for audio content of the data item and does not typically use metadata (or descriptive information), if present. A decision 418 can then determine whether the requested fingerprint data has been received. When the decision 418 determines that the requested fingerprint data has not been received, the data matching process 400 can await such data.

Once the decision 418 determines that the requested fingerprint data has been received, a decision 420 can determine whether any of the fingerprint data for the remaining local data items matches fingerprint data of remote cloud data items already resident in the cloud data repository. When the decision 420 determines that the fingerprint data for one or more of the remaining local data items does match fingerprint data of one or more corresponding remote cloud data items, the one or more matched items can be added 442 to the cloud data repository by association to corresponding remote cloud data items. Following the decision 420 when there are no fingerprint matches, or following the block 442 when there are fingerprint matches, the data matching process 400 can end.

In the embodiment of the data matching process 400 illustrated in FIGS. 4A and 4B, there are three different avenues to provide matching with respect to data already available in the cloud data repository. The first matching test uses identifiers (e.g., assigned identifiers), the second matching test uses hash values, and the third matching test utilizes fingerprints. If matches are identified using any of these series of matching tests, the corresponding data items from the local device data need not be copied to the cloud data repository because such data is already resident in the cloud data repository. If one or more of the local data items within the local device data are not able to be matched in any way, the local data items can be uploaded to the cloud data repository (e.g., FIG. 2B, block 214).

It should also be noted that the data matching process 400 assumes that all three stages of matching are generally utilized.

The data matching process 400 illustrated in FIGS. 4A and 4B is, for example, well suited for matching local device data, such as media content. Examples of media content include: songs, videos, audiobooks, music videos, podcasts. However, in one embodiment, in the case where the media content includes associated artwork, the matching and upload processing for the artwork can be performed separately. Since users of media content (e.g., songs) can be permitted to customize the associated artwork, the artwork for a given media content can be user dependent. As such, separately processing artwork for media content can maintain the ability to support user customization of artwork for media content.

Additionally, it should be noted that the operations 416-420 of the data matching process 400 can be performed one or more time for one or more different types of fingerprints. For example, a first pass through operations 416-420 could us a partial fingerprint, and then a second pass, if needed, could use a full (or intermediate) fingerprint to evaluate data matching. By using such a tiered fingerprint approach allows for more efficient, reliable and cost effective solution. As one implementation, a partial fingerprint could pertain to a limited duration of a data item, such as between (10) to forty (40) seconds, and a full fingerprint could pertain to the entire duration of a data item. Also, the fingerprint can be referred to as an acoustic fingerprint or an audio fingerprint.

Still further, any of the match processing 350, 360 and 370 illustrated in FIGS. 3B. 3C and 3D can represent more detailed processing that can be performed to implement the decision 420 of the data match processing 400, according to one embodiment (though operation 310 would be replaced by operation 442, and operation 312 would result in conclusion of the data match processing 400.

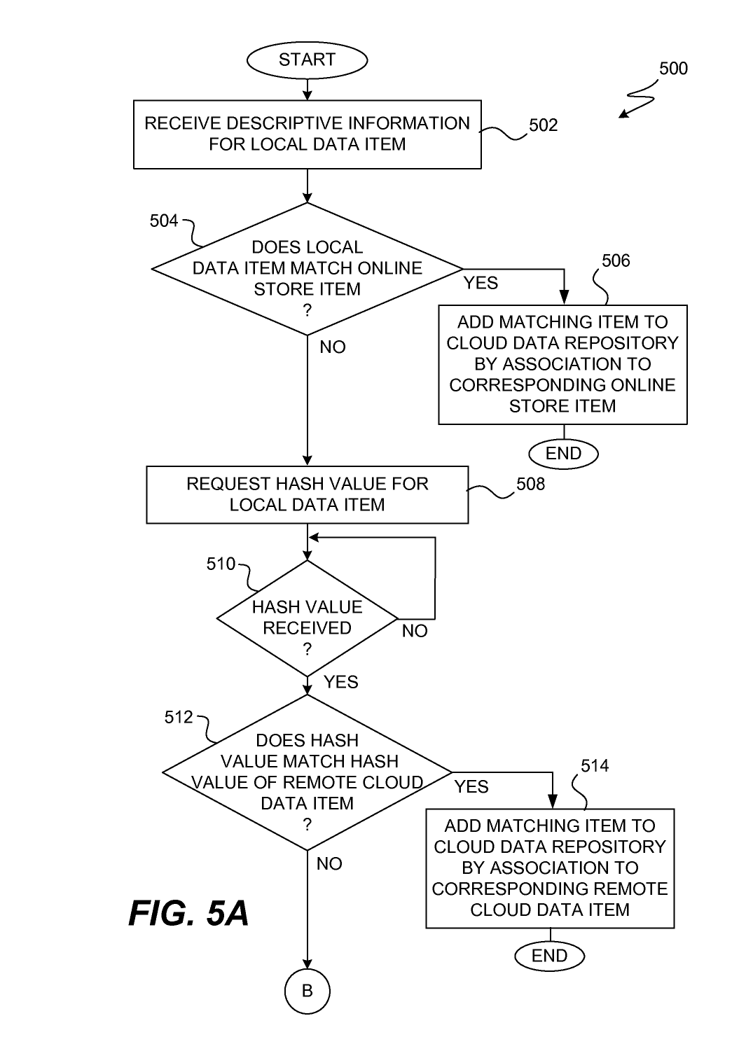

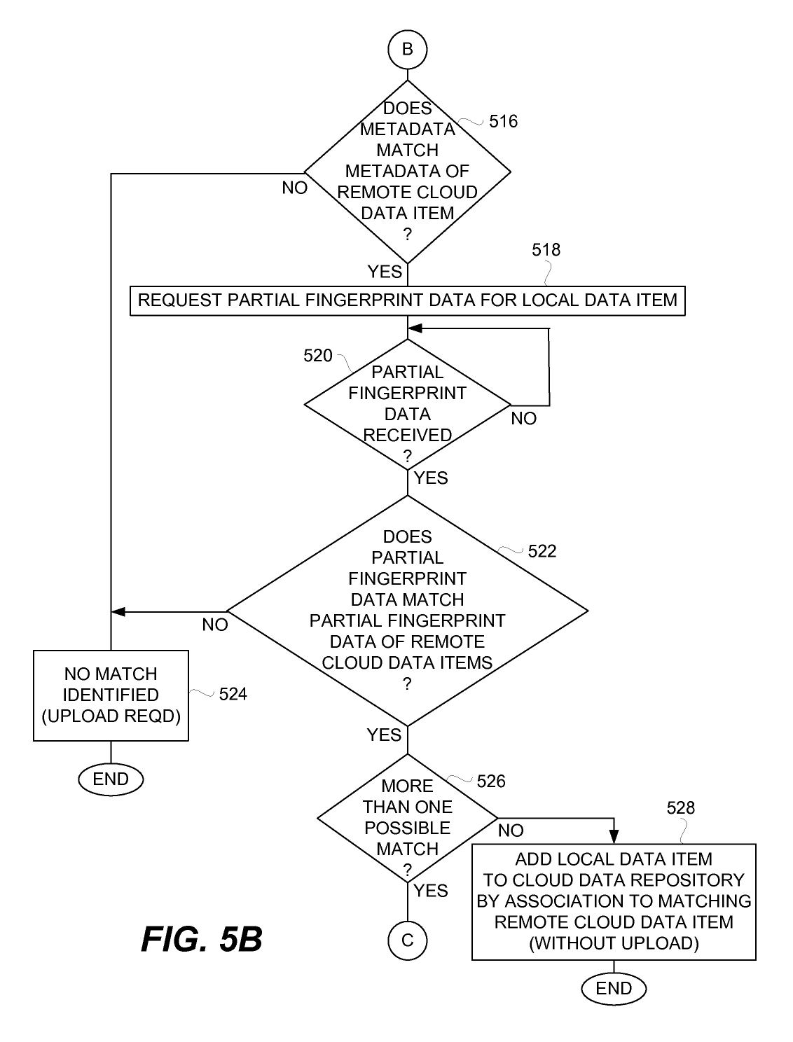

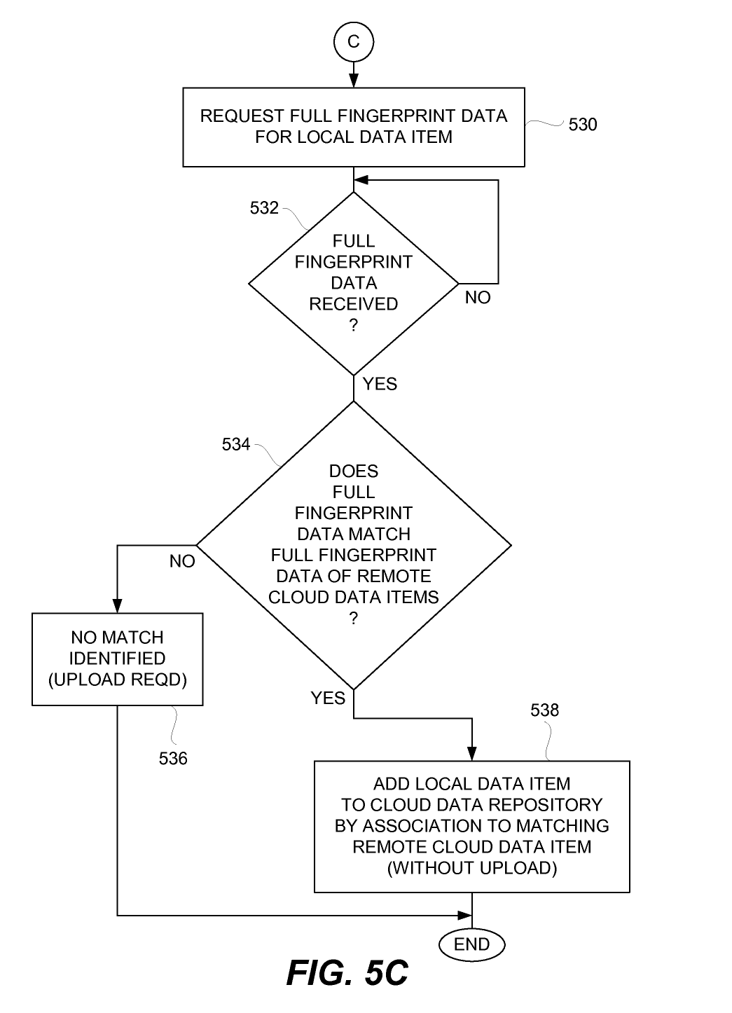

FIGS. 5A-5C illustrate a flow diagram of a data matching process 500 according to one embodiment. The data matching process 500 can, for example, represent a more detailed process than the processing performed by the block 208 illustrated in FIG. 2A or the data matching process 300 illustrated in FIG. 3A. The data matching process 500 can be performed by a computing device, such as the cloud server 102 illustrated in FIG. 1.

The data matching process 500 can receive 502 descriptive information for a local data item. The descriptive information serves to describe characteristics or attributes for the local data item. As an example, the descriptive information can include metadata well as one or more identifiers for the various local data items within the local device data. The metadata can describe the corresponding data items. For example, for a digital media asset, the metadata can specify attributes such as title, artist, genre, user-rating, etc. The metadata might also specify characteristics such as bit rate, encoding, duration, etc. The one or more identifiers are typically assigned such that they are unique for a given digital item. For example, an online store (e.g., digital content store 116) can assign unique identifiers to each of its digital online store items that are offered to users for acquisition.

Next, a decision 504 can determine whether the local data item matches an online store item known to the cloud data repository. Here, the one or more identifiers provided in the descriptive information can be utilized to compare to identifiers associated with online store items available at the online store. When the decision 504 determines that there is a match, the match indicates that the local data item was acquired from the online store and thus has a matching identifier. In this case, the matched item can be added 506 to the cloud data repository by association to the corresponding online store item. Hence, after the matched item is added 506 by association, and thus without the need for uploading, the match has been found and the data matching process 500 can end.

Alternatively, when the decision 504 determines that the local data item does not match any of the online store items, a hash value for the local data item can be requested 508. Here, the computing device performing the data matching process 500 (e.g., cloud server 102) can request the hash value from the particular client device being activated. A decision 510 can then determine whether the requested hash value have been received. When the decision 510 determines that the requested hash value has not yet been received, the data matching process 500 can await the requested hash value.

Once the decision 510 determines that the requested hash value has been received, a decision 512 can determine whether the requested hash value matches any hash values of remote cloud data items. Here, the requested hash value pertains to a digital identifier that is computed from the electronic file containing or associated with a given data item. The hash value can thus be used to identify identical electronic files. As an example, the hash value utilized can result from using an MD5 hash algorithm. When the decision 512 determines that the requested hash value for the local data item matches a hash value for a remote cloud data item, the corresponding local data item can be thus identified as matching a remote cloud data item already provided in the cloud storage. Hence, in this case, the matching item can be added 514 to the cloud data repository by association to the corresponding remote cloud data item. After the matched item is added 514 by association, and thus without the need for uploading, the match has been found and the data matching process 500 can end.

Alternatively, following the decision 512 when the requested hash value does not match any hash values of remote cloud data items, a decision 516 can determine whether metadata for the local data item matches metadata of a remote cloud data item. When the decision 516 determines that the metadata for the local data item does not match metadata of any of the remote cloud data items, no match for the local data item has been identified 524 at the cloud data repository. In this case, upload of the local data item will be required. Following the block 524, the data matching process 500 can end.

On the other hand, when the decision 516 determines that metadata for the local data item does match metadata of one or more of the remote cloud data items, additional processing can be performed by the data matching process 500 to determine whether an appropriate match can be found at the cloud data repository. In this regard, partial fingerprint data for the local data item can be requested 518. A decision 520 can then determine whether the partial fingerprint data has been received. When the decision 520 determines that the partial fingerprint data has not yet been received, the data matching process 500 can await receipt of the partial fingerprint data. However, when the decision 520 determines that the partial fingerprint data has been received, a decision 522 can determine whether the partial fingerprint data matches partial fingerprint data for any of the remote cloud data items. When the decision 522 determines that the partial fingerprint data for the local data item does not match the partial fingerprint data for any of the remote cloud data items, the data matching process 500 can proceed to the block 524, which identifies that no match for the local data item has been found and thus the data matching process 500 can end.

On the other hand, when the decision 522 determines that the partial fingerprint data for the local data item does match the partial fingerprint data for one or more of the remote cloud data items, a decision 526 can determine whether there are one or more possible matches. In other words, if the decision 526 determines that there is only one remote cloud data item with partial fingerprint data that matches the partial fingerprint data for the local data item, then the local data item can be added 528 to the cloud data repository by association to the matching remote cloud data item. In this case, since the local data item has been determined to match a remote cloud data item, there is no need for upload of the local media item to the cloud data repository. Following the block 528, the data matching process 500 can end without requiring upload of the local data item.

Alternatively, when the decision 526 indicates that there are more than one possible matches for the local data item at the cloud data repository, additional processing can be performed by the data matching process 500 to identify the remote cloud data item that precisely matches the local data item. In this regard, full fingerprint data for the local data item can be requested 530. A decision 532 can then determine whether the full fingerprint data for the local data item has been received. When the decision 532 determines that the full fingerprint data for the local data item has not yet been received, the data matching process 500 can await such data. Once the decision 532 determines that the full fingerprint data for the local data item has been received, a decision 534 can determine whether the full fingerprint data matches the full fingerprint data for the remote cloud data items. Here the decision 534 need only evaluate the full fingerprints for those of the remote cloud data items that were identified as possible matches by the partial fingerprint matching. When the decision 534 determines that the full fingerprint data for the local data item does not match the full fingerprint data for any of the remote cloud data items, no match for the local data item has been identified 536 at the cloud data repository. In this case, upload of the local data item will be required. Following the block 536, the data matching process 500 can end.

On the other hand, when the decision 534 determines that the full fingerprint data for the local data item does match the full fingerprint data for one or more of the remote cloud data items, then the local data item can be added 538 to the cloud data repository by association to the matching remote cloud data item. In this case, since the local data item has been determined to match a remote cloud data item, there is no need for upload of the local media item to the cloud data repository. Following the block 538, the data matching process 500 can end without requiring upload of the local data item.

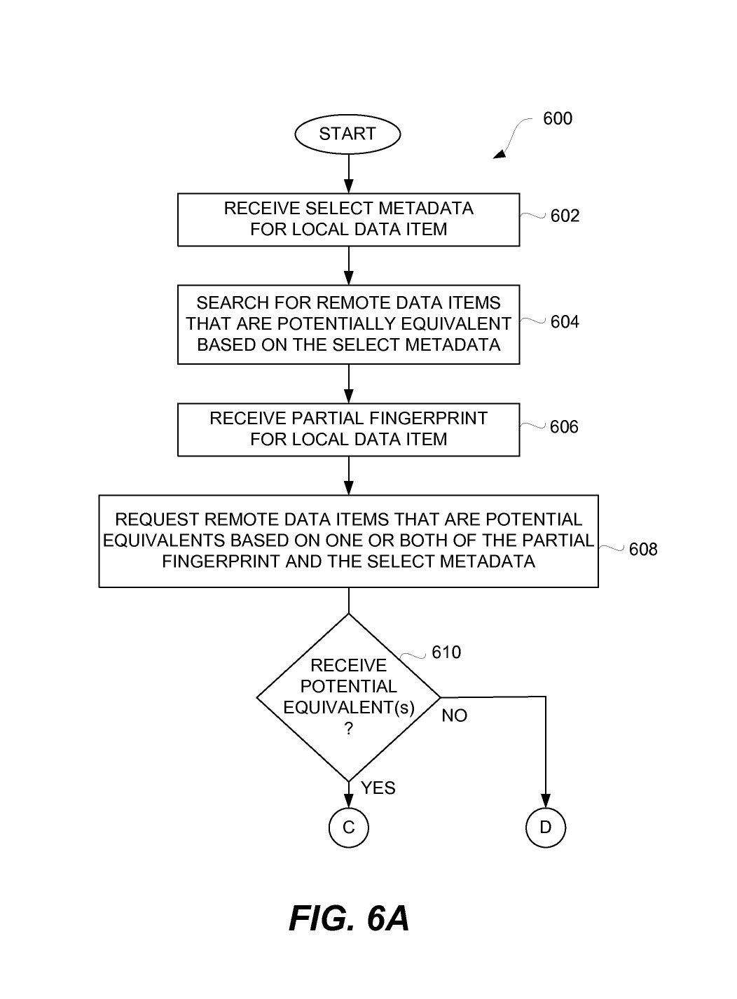

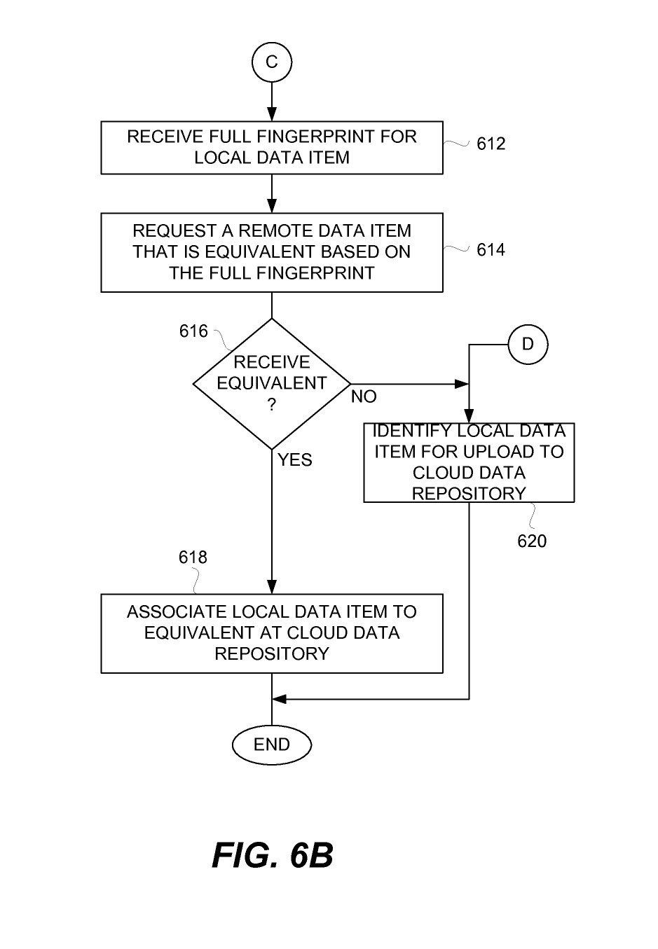

FIGS. 6A and 6B are flow diagrams of a data matching process 600 according to one embodiment. The data matching process 600 can, for example, represent a more detailed process than the processing performed by the block 208 illustrated in FIG. 2A or the data matching process 300 illustrated in FIG. 3A. The data matching process 600 can be performed by a computing device, such as the cloud server 102 illustrated in FIG. 1.

The data matching process 600 can receive 602 select metadata for a local data item. Then, the data matching process 600 can search 604 for remote data items that are potentially equivalent to the local data item based on the select metadata for the local data item. The metadata is more generally referred to as descriptive information. A partial fingerprint for the local data item can also be received 606. Thereafter, one or more remote data items that are potential equivalents to the local data item based on one or both of the partial fingerprint and the metadata can be requested 608. In one implementation, the potential equivalents are those data items that have matching select metadata as well as matching partial fingerprints. In another implementation, the potential equivalents are those data items that have matching select metadata or matching partial fingerprints. A decision 610 can determine whether any potential equivalents have been received.

When the decision 610 determines that one or more remote data items have been identified as potential equivalents, a full fingerprint for the local data item can be received 612. Then, a remote data item that is equivalent to the local data item based on the full fingerprint can be requested 614. Next, a decision 616 can determine whether a remote data item has been identified as an equivalent have been received. When the decision 616 determines that an equivalent have been received, the local data item can be associated 618 to the remote data item at the cloud data repository that has been identified as being equivalent. Alternatively, when the decision 616 determines that no equivalent has been received, the local data item can be identified 620 for upload to the cloud data repository. Following the block 618 and the block 620, the data matching process 600 can end.

On the other hand, when the decision 610 determines none of the remote data items have been identified as potential equivalents, the local data item can be identified 620 for upload to the cloud data repository. Following the block 618 and a block 620, the data matching process 600 can end.

With the data matching process 600, for a remote data item to be considered an equivalent to the local data item, the remote data item needs to match not only the select metadata but also the partial fingerprint. Furthermore, if there is a need for confirming such a matching remote data item, a full fingerprint can be performed. For example, if there are multiple matches resulting from use of metadata and the partial fingerprint, the full fingerprint can be perform to select the best match. The use of metadata to search for equivalents can, for example, be used to filter (e.g., pre-filter) to identify potential matching candidates that can be further processed for confirmation of equivalency. As another example, if there an indication that any of the unconfirmed matches (or the local data item) are known to be contain “explicit” content, then to confirm the exact match, the full fingerprint can be used.

According to another aspect, an data asset association database can be formed. The data asset association database can associate hash values for local data items to data item identifiers (e.g., store identifiers). For example, following a successful match, the hash value for the local data item can be stored in the data asset association database along with the corresponding identifier for the matching remote data item. Here, in one embodiment, the matching can use only confirmed matches. In another embodiment, the matching can use both confirmed and unconfirmed matches. When the data asset association database is available, in one embodiment, the data match processing discussed above can use the data asset association database as a “cache,” which can provide efficient identification of a matching remote data item for a local media item using a hash value of the local data item. For example, the data asset association database can be used at the decision 306 of the data matching process 300 is quickly determine whether an identifier for a remote data item has already been matched with a hash value for the local data item.

In view of the foregoing, it will readily be known that an electronic device provided in accordance with one or more embodiments can, for example, be a computing device (e.g., personal computer), mobile phone (e.g., cellular phone, smart phone), personal digital assistant (PDA), media player (e.g., music, videos, games, images), media storage device, camera, and/or the like. A computing device typically includes at least a processor and memory. The memory can store computer program code and the processor can execute the computer program code stored in the memory. An electronic device may also be a multi-functional device that combines two or more of these device functionalities into a single device. A portable electronic device may support various types of network communications.

A portable electronic device can be provided as a hand-held electronic device. The term hand-held can generally refer to an electronic device with a form factor that is small enough to be comfortably held in one hand. A hand-held electronic device may be directed at one-handed operation or two-handed operation. In one-handed operation, a single hand is used to both support the device as well as to perform operations with the user interface during use. In two-handed operation, one hand is used to support the device while the other hand performs operations with a user interface during use or alternatively both hands support the device as well as perform operations during use. In some cases, the hand-held electronic device is sized for placement into a pocket of the user. By being pocket-sized, the user does not have to directly carry the device and therefore the device can be taken almost anywhere the user travels (e.g., the user is not limited by carrying a large, bulky and often heavy device).

Digital media assets (e.g., digital media items) can, for example pertain to video items (e.g., video files or movies), audio items (e.g., audio files or audio tracks, such as for songs, musical albums, podcasts or audiobooks), or image items (e.g., photos). The digital media assets can also include or be supplemented by text or multimedia files.

Additional information on digital asset delivery is provided in: (i) U.S. patent application Ser. No. 13/488,339, filed Jun. 4, 2012, entitled “MANAGEMENT OF NETWORK-BASED DIGITAL DATA REPOSITORY,” which is herein incorporated by reference; (ii) U.S. patent application Ser. No. 13/488,336, filed Jun. 4, 2012, entitled “MANAGEMENT OF NETWORK-BASED DIGITAL DATA REPOSITORY,” which is herein incorporated by reference; (iii) U.S. patent application Ser. No. 13/488,317, filed Jun. 4, 2012, entitled “REMOTE STORAGE OF ACQUIRED DATA AT NETWORK-BASED DIGITAL DATA REPOSITORY,” which is herein incorporated by reference; (iv) U.S. patent application Ser. No. 13/488,320, filed Jun. 4, 2012, entitled “REGULATED ACCESS TO NETWORK-BASED DIGITAL DATA REPOSITORY,” which is herein incorporated by reference; and (v) U.S. patent application Ser. No. 13/488,290, filed Jun. 4, 2012, entitled “MANAGEMENT OF DOWNLOADS FROM A NETWORK-BASED DIGITAL DATA REPOSITORY,” which is herein incorporated by reference.

The invention is preferably implemented by software, hardware, or a combination of hardware and software. The invention can also be embodied as computer readable code on a computer readable medium. The computer readable medium is any data storage device that can store data which can thereafter be read by a computer system, including being executed by a processor of a computer system. Examples of the computer readable medium generally include read-only memory and random-access memory. More specific examples of computer readable medium are tangible (and non-transitory) and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

The various aspects, features, embodiments or implementations of the invention described above can be used alone or in various combinations.

The advantages of various embodiments of the invention are numerous. Different aspects, embodiments or implementations may, but need not, yield one or more of the following advantages. One advantage of at least some embodiments is that common digital assets can identified (e.g., matched) in an efficient manner. The improved efficiency can be in terms of time, bandwidth and/or cost. Another advantage of at least some embodiments is that digital assets can be compared using a multi-tiered approach, which can be reliable and resource efficient.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method comprising:
receiving a partial digital fingerprint associated with a local digital data item, the local digital data item being stored at a client device;
comparing the partial digital fingerprint associated with the local digital data item with respective partial digital fingerprints associated with a plurality of remote digital data items to yield a first comparison, the remote digital data items being stored at a remote data repository;
based on the first comparison, identifying a remote digital data item having an associated partial digital fingerprint that matches the partial digital fingerprint associated with the local digital data item;
after identifying, based on the first comparison, the remote digital data item having the associated partial digital fingerprint that matches the partial digital fingerprint associated with the local digital data item, comparing a first full digital fingerprint associated with the local digital data item with a second full digital fingerprint associated with the remote digital data item to yield a second comparison; and
based on the second comparison, determining that the remote digital data item is equivalent to the local digital data item.

2. A method as recited in claim 1, wherein the local digital data item is an audio media item, and wherein the remote digital data item is an audio media item.

3. A method as recited in claim 1, wherein the local digital data item has a duration, and wherein the partial fingerprint associated with the local digital data item corresponds to a predetermined limited duration that is less than the duration.

4. A method as recited in claim 3, wherein the predetermined limited duration is thirty (30) seconds.

5. A method as recited in claim 1, wherein the method comprises:
receiving descriptive information for the local digital data item;
comparing the descriptive information for the local digital data item with descriptive information for the plurality of remote digital data items; and
identifying a set of one or more of the remote digital data items that is deemed to match the local digital data item based on results of the comparing of the descriptive information.

6. A method as recited in claim 5, wherein the method comprises:
restricting, prior to the second comparison, those of the plurality of remote digital data items that are deemed to match the local digital data item.

7. A method as recited in claim 1, wherein the method comprises:
obtaining an identifier for the remote digital data item based on results of the second comparison; and
storing the identifier in a data storage component for subsequent use in identifying matching digital data items.

8. A method as recited in claim 7, wherein the method comprises:
receiving a hash value for the local digital data item;
searching the data storage component for an entry having the hash value;
retrieving a stored identifier from the data storage component if the data storage component includes an entry having the hash value; and
determining that the remote digital data item is equivalent to the local digital data item based on results of the stored identifier.

9. (canceled)

10. A non-transitory computer readable medium including at least computer program code stored therein for identifying equivalent data items at remote data repository, the computer readable medium comprising:
computer program code for receiving a partial digital fingerprint associated with a local data item, the local digital data item being stored at a client device;
computer program code for requesting a first comparison of the partial digital fingerprint associated with the local digital data item with respective partial digital fingerprints associated with a plurality of remote digital data items, the remote digital data items being stored at the remote data repository;
computer program code for receiving a first indication of a remote digital data item having an associated partial digital fingerprint matching the partial digital fingerprint associated with the local digital data item based on results of the first comparison;
computer program code for requesting a second comparison of a first full digital fingerprint associated with the local digital data item with a second full digital fingerprint associated with the remote digital data item; and
computer program code for receiving a second indication that the remote digital data item matches the local digital data item based on results of the second comparison.

11. A non-transitory computer readable medium as recited in claim 10, wherein the local digital data item is an audio media item, and wherein the remote digital data item is an audio media item.

12. A non-transitory computer readable medium as recited in claim 10, wherein the local digital data item has a duration, and wherein the partial fingerprint associated with the local digital data item corresponds to a predetermined limited duration that is less than the duration.

13. A non-transitory computer readable medium as recited in claim 12, wherein the predetermined limited duration is in a range of twenty (20) to thirty (30) seconds.

14. A non-transitory computer readable medium as recited in claim 10, wherein the computer readable medium comprises:
computer program code for receiving descriptive information for the local digital data item;
computer program code for comparing the descriptive information for the local digital data item with descriptive information for the plurality of remote digital data items to yield a third comparison; and
computer program code for identifying one or more of the plurality of remote digital data items that are deemed to match the local digital data item based on results of the third comparison.

15. A non-transitory computer readable medium as recited in claim 14, wherein the computer readable medium comprises:
computer program code for restricting, prior to the second comparison, those of the plurality of remote digital data items that are deemed to match the local digital data item.

16. A non-transitory computer readable medium as recited in claim 10, wherein the computer readable medium comprises:
computer program code for obtaining an identifier for remote digital data item based on results of the first comparison; and
computer program code for storing the identifier to a data storage component for subsequent use in identifying matching digital data items.

17. A non-transitory computer readable medium as recited in claim 16, wherein the computer readable medium comprises:
computer program code for receiving a hash value for the local digital data item;
computer program code for searching the data storage component for an entry having the hash value;
computer program code for retrieving a stored identifier from the data storage component when the data storage component includes an entry having the hash value; and
computer program code for identifying a set of one or more of the remote digital data items that match the local digital data item based on results of the stored identifier.

18. (canceled)

19. A system comprising:
a processor;
a remote data repository configured to store digital data for a plurality of account holders, the remote data repository being accessible by authorized client devices via the network; and
a computer-readable storage medium having stored therein instructions which, when executed by the processor, cause the processor to perform operations comprising:
receiving a partial digital fingerprint associated with a local digital data item, the local digital data item being stored at a client device;
comparing the partial digital fingerprint associated with the local digital data item with respective partial digital fingerprints associated with a plurality of remote digital data items to yield a first comparison;
based on the first comparison, identifying a remote digital data item having an associated partial digital fingerprint matching the digital fingerprint associated with the local digital data item;
after identifying, based on the first comparison, the remote digital data item having the associated partial digital fingerprint matching the partial digital fingerprint associated with the local digital data item, comparing a first full digital fingerprint associated with the local digital data item with a second full digital fingerprint associated with the remote digital data item to yield a second comparison; and
based on the second comparison, determining that the remote digital data item matches the local digital data item.
